(19) United States
(12) Patent Application Publication
(10) Pub. No.: US 2013/0060769 A1
(43) Pub. Date: Mar. 7, 2013

(54) SYSTEM AND METHOD FOR IDENTIFYING SOCIAL MEDIA INTERACTIONS

(71) Applicants: Oren PEREG, Amikam (IL); Ezra Daya, Petah-Tikwah (IL); Maya Gorodetsky, Modiin (IL)

(72) Inventors: Oren PEREG, Amikam (IL); Ezra Daya, Petah-Tikwah (IL); Maya Gorodetsky, Modiin (IL)

(21) Appl. No.: 13/223,608

(22) Filed: Sep. 1, 2011

(51) Int. Cl. G06F 17/30

(52) U.S. Cl. 707/728; 707/765; 707/E17.074

(57) ABSTRACT

A system and method for searching data, such as, text data, using a processing component. A query including one or more terms may be received. At least one term may be automatically added to the query to generate an expanded query set. Entries from one or more information sources, such as, Internet posts, may be retrieved. The retrieved entries may include terms that match terms in the expanded query set. The relevancy of each retrieved entry to the query may be automatically determined. A search result may be provided including a subset of the retrieved entries that are determined to have sufficient relevancy to the query. An output device may display the search result to a client or user.

### FIELD OF THE INVENTION

The present invention relates to methods and systems for searching for digital data, for example, in a shared or public network, such as, the Internet.

### BACKGROUND OF THE INVENTION

Customers may use Internet and social media platforms to review and discuss company or product performance. Product developers or company representatives may want to monitor such posts related to their company. However, some company or product names may have multiple diverse meanings and a search for those names may produce search results of both relevant and irrelevant posts. Furthermore, the language used to review topics may also be diverse and may include, e.g., abbreviations, acronyms, nicknames or SMS language (“Textese”), which may not exactly match the proper names being searched.

### SUMMARY OF EMBODIMENTS OF THE INVENTION

In an embodiment of the invention, a system and method is provided for searching data. A query including one or more terms may be received. At least one term may be automatically added to the query to generate an expanded query set. Entries from one or more information sources, such as, Internet posts, may be retrieved. The retrieved entries may include terms that match terms in the expanded query set. The relevancy of each retrieved entry to the query may be automatically determined. A search result may be provided including a subset of the retrieved entries that are determined to have sufficient relevancy to the query. An output device may display the search result to a client or user.

In an embodiment of the invention, a system and method is provided for searching an information source for entries matching a search query. The relevancy of each retrieved entry to the query may be determined using positive examples of entries predefined to be relevant to the search query and negative examples of predefined to be irrelevant to the search query. The positive and negative examples may be defined by a model, such as, a clustering model or a classification model. A search result may be provided including entries determined to be relevant to the search query.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings. Specific embodiments of the present invention will be described with reference to the following drawings, wherein:

FIG. 1 is a schematic illustration of a system for searching for data relevant to a search query using query expansion and disambiguation in accordance with embodiments of the invention;

FIG. 2 is a schematic illustration of a workflow for searching for data relevant to a search query using query expansion and disambiguation in accordance with embodiments of the invention;

FIG. 3 is a schematic illustration of a system workflow for a clustering process in accordance with embodiments of the invention;

FIG. 4 is a schematic illustration of an example of a clustering model in accordance with embodiments of the invention;

FIG. 5 is a schematic illustration of a system workflow for a process of training a classifier in accordance with embodiments of the invention;

FIG. 6 is a schematic illustration of a query expansion model accordance with embodiments of the invention;

FIGS. 7-9 are schematic illustrations of graphical user interfaces (GUIs) for visualizing cross-channel content analysis in accordance with embodiments of the invention; and

FIG. 10 is a schematic illustration of a workflow for executing a query search in accordance with embodiments of the invention.

It will be appreciated that for simplicity and clarity of illustration, elements shown in the figures have not necessarily been drawn to scale, For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

A “post” or “entry” may include information available via a public or private communication channel, such as, e-mail, telephone calls, text messaging, Internet websites, Wogs, microblogs, social media networks, such as Facebook, Twitter, and Myspace, online or telephone surveys, etc.

Current systems may search for posts that exactly match a search query or that are “close” or “similar” to approximately match the search query, for example, that difThr from the original search query by one or more letters. However, such systems do not account for the wide variety of language used to describe the same entity (e.g.,, company, product, celebrity). For example, just as a celebrity or politician may have a wide variety of nicknames or titles (e.g., Barak Obama may also be referred to as “President,” “Commander-in-Chief,” “POTUS” (President of the United States), “Bam,” and a slew of satirical nicknames), a company may also have a wide variety of associated names (e.g., “Fidelity Investments,” “Fidelity,” “fidelity.com,” “Fidelity Brokerage Services,” “Fidelity”).

To accurately track posts directed to an entity, embodiments of the invention may expand searches for a query term, not only to terms with similar spelling, but also to terms with similar usage. Embodiments of the invention may determine different forms of an entity name or query term, for example, by searching for similar root terms, synonyms or other morphological or lexicological variations in websites or databases that refer to the original query. Embodiments of the invention may generate an expanded query set including the original query term (e.g., a proper name) and a plurality of alternative terms (e.g., nicknames). A user may confirm or add terms to expand the query set and/or delete terms from the proposed list to narrow the query set. When used herein, “term” typically includes text, such as one or more words, partial words, roots, combinations of letters or characters, or combinations thereof.

Once the plurality of terms are selected in the query set, a search mechanism may search for those terms in posts in information sources and/or databases, such as micro blogs, e-mails, call center recordings, Internet web pages or websites,

Searching information sources or databases for an expanded query set may enlarge the scope of the original search to multiple forms of an entity name. However, in some cases, the expansion may extend too far, for example, detecting matches that are tangentially related or completely unrelated to the original search query. For example, in the case of the query for “Fidelity Investments”, after having been expanded to include the term “fidelity,” a test search for “fidelity” was found to retrieve 63% of the matching posts or entries related to songs, movies and other entries for a different term usage of “loyalty,” 15% related to other companies with the name “fidelity,” and only 22% related to the well-known firm “Fidelity Investments.”

Accordingly, to balance the expansion of the query set, embodiments of the invention may restrict or narrow the resulting search results to include only search results determined to be “relevant”, for example, based on subject matter or topic in the information source website or database post. Automatically expanding the search input to different forms of a query while narrowing the search results (e.g., the search range) based on relevancy may generate more accurate search results.

Embodiments of the invention may use a relevancy criterion when searching. A search result may include posts or entries that (a) match the (exact or approximate) spelling of a query and that (b) are determined to be relevant to the query. Embodiments of the invention may train systems to generate models to determine relevancy using example entries or past entries predefined to be relevant or irrelevant. Such systems may use trends of the example or past entries to determine if a new entry is relevant to the query.

Some embodiments of the invention may use a clustering process to determine the relevancy of an entry to a query. Example or past entries may be “clustered” or grouped with other entries that have the same or similar subject matter. Each group or subject matter may be defined to be relevant or irrelevant to the query. Accordingly, if a new entry (e.g., which matches the spelling of the query) is within a relevant group, the entry may be a positive search result, while if the entry is within an irrelevant group, the entry may be a negative search result.

Embodiments of the invention may use a classification process to determine the relevancy of an entry to a query. The classification process may include a. training stage in which a classifier is trained to determine relevancy for the query by inputting examples of positive (e,g., relevant) entries and negative (e.g., irrelevant) entries, for example, into an iterative self-training process. A classifier may be generated for each search query (e.g., including all terms in the expanded query set), which classifies every new input entry as either relevant or irrelevant to the search query.

Once the relevant search results for a target entity are found, they may be analyzed, for example, to monitor Internet and social media posts related to the target entity or topic. In some embodiments, lists, charts, graphs or other displays may be used to visualize search results in a comprehensive manner.

Although embodiments of the invention are described to search for information related to a specific target entity, such as, a company or product, such embodiments may be used to search for information related to any subject matter, for example, including a news event, technological field or innovation, geographical location or any other topic or item of interest. Furthermore, embodiments of the invention may be used to search for a post in any information source(s) including databases, e-mails, telephone or voice recordings, surveys, websites, blogs, microblogs, social media networks, such as Facebook, Twitter, Myspace, etc. Some service providers, such as Twitter, may provide an interface, such as, a plug-in or Application Programming Interface (API), adapted for users to search. The analysis engine may search each provider interface with an API generated by the service provider.

Although many examples shown herein relate to micro-blog posts, other information sources, such as databases, e-mail, telephone call centers, web pages, and text corpuses, may be used or searched.

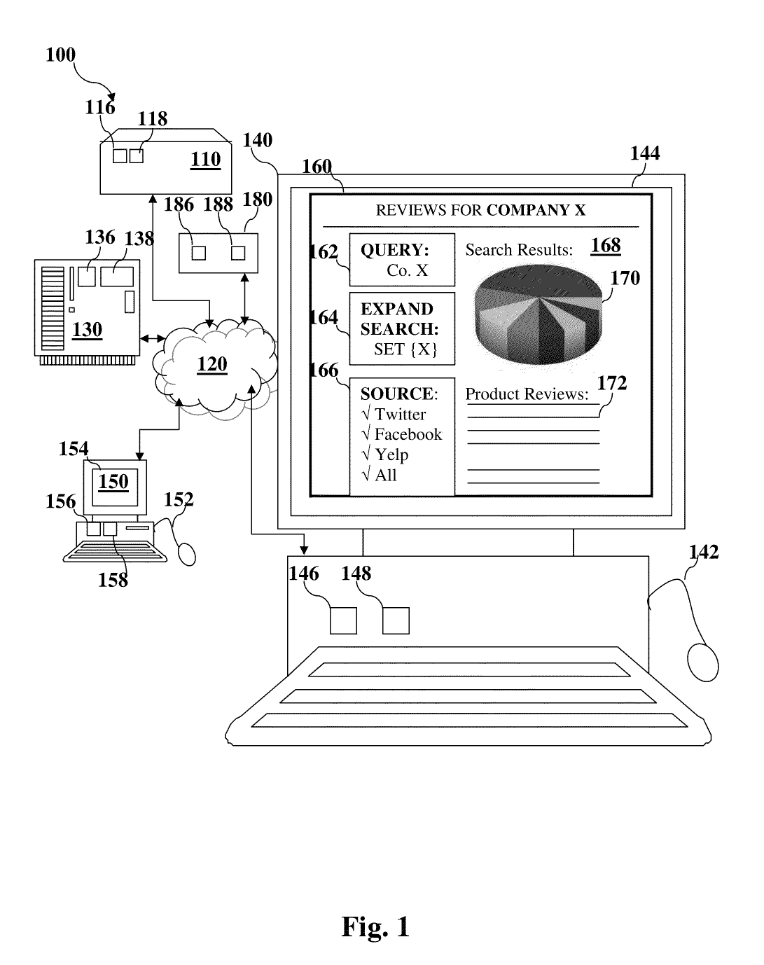

Reference is made to FIG. 1, which schematically illustrates a system 100 for searching for network data relevant to a search query using query expansion and disambiguation in accordance with embodiments of the invention.

System 100 may include one or more network servers 110 to provide information over a network, one or more network hosts 130, one or more user computers 150 to post information over a network, and a client computer 140 to monitor posts over one or more networks, all of which are connected via one or more networks 120 such as the Internet.

Network server 110 may include a computing device for hosting and distributing information over network 120. Network server 110 may be a social media service, such as, a blog, Twitter, Facebook, an e-mail service, or product review website, Network server 110 may accumulate posts from one or more user computer(s) 150.

User computer(s) 150, e.g., controlled by a user, may post data, such as, e-mails, blogs, microblogs. Tweets, reviews or comments, to websites and social media forums hosted by network host 130 via network 120.

Client computer 140, e.g., controlled by a client, may search network content for posts generated by user computer(s) 150 that match the spelling and context of a query.

User computer(s) 150 and client computer 140 may include one or more input devices 152 and 142, respectively, for receiving input from a user (e.g., a pointing device, click-wheel or mouse, keys, touch screen, recorder/microphone, other input components). User computer(s) 150 may include one or more output devices 154 (e.g., a monitor or screen) for displaying to a user web pages hosted by web host 130. Client computer 140 may include one or more output devices 144 for displaying to a client a search interface 160 having entry fields and uploading capabilities for designing, selecting and monitoring searches.

Web host 130 may include a computer or computer system capable of hosting a web site or other communication channel for distributing information from network server 110.

Client computer 140 may use an analysis engine 180, e.g., operated or executed remotely by a server processor 186 (or locally by processor 146), to determine the relevancy of search results to a query defined by the client. Analysis engine 180 may identify the subset of posts with a high level of relevance to a given entity (e.g., disambiguation) for a query set expanded to more completely define the entity (e.g., query expansion). Analysis engine 180 may use any device or mechanism for searching text or other media formats, for example, including text searching and/or pattern recognition mechanisms, which may search raw or pre-indexed data posted over network 120. Analysis engine 180 may be or may include a processing component or a processor (e.g., processor 186).

Network 120, which connects network server 110, network host 130, client computer 140, user computer(s) 150, and analysis engine 180, may be any public or private network such as the Internet, Access to network 120 may be through wire line, terrestrial wireless, satellite or other systems. More than one network 120 may be used to access different media formats and/or information sources with different accessibility or security restrictions.

Network server 110, network host 130, client computer 140, user computer(s) 150, and analysis engine 180, may include one or more controller(s) or processor(s) 116, 136, 146, 156, and 186, respectively, for executing operations and one or more memory unit(s) 118, 138, 148, 158, and 188, respectively, for storing data and/or instructions (e.g., software) executable by a processor, for example for carrying out methods as disclosed herein. Processor(s) 116, 136, 146, 156 and/or 186 may include, for example, a central processing unit (CPU), a digital signal processor (DST), a microprocessor, a controller, a chip, a microchip, an integrated circuit (IC), or any other suitable multi-purpose or specific processor or controller. Memory unit(s) 118, 138, 148, 158 and/or 188 may include, for example, a random access memory (RAM), a dynamic RAM (DRAM), a flash memory, a volatile memory, a non-volatile memory, a cache memory, a buffer, a shod, term Memory unit, a long term memory unit, or other suitable memory units or storage units.

Analysis engine 180 may execute or run a user interface 160 on client computer 140 for interacting with the client, for example, to receive search information or parameters from the client and send search results to the client. User interface 160 may include for example a query field 162, an expanded search set field 164 and/or a source field 166. The client may enter one or more search terms for the query into query field 162, e.g., via input device 142. Analysis engine 180 may execute a query expansion operation to generate a plurality of search terms in expanded search set field 164 extrapolated from the initial search term in query field 162. Expanded search set field 164 may be edited by the user or client, for example, by adding or deleting search terms, and/or approved by the user or client. Source field 166 may indicate the information sources to be searched, which may be selected automatically and/or edited by the client.

Once the query and information sources are sent to analysis engine 180 (e.g., via user interface fields 164 and 166 on client computer 140), analysis engine 180 may perform or execute a search for terms. For example, a search may be for user posts contained or displayed within the information sources that match the query, or for other text in Internet web pages, databases, or other sources. Analysis engine 180 may initially retrieve entries from the information sources that match the (exact or approximate) spelling of the query, for example, differing from one of the terms in the extended query set by none or a below threshold number of letters. Each retrieved entry may undergo a second test, e.g., disambiguation, to determine if the entry is relevant to the query. To determine relevancy, analysis engine 180 may assign each retrieved entry to one of a plurality of groups having other entries most similar to the retrieved entry. Each of the plurality of groups of entries may be predefined as relevant or irrelevant (or associated with a predefined degree of relevancy, which may change as the group grows) to the search query. Analysis engine 180 may provide each retrieved entry as a search result 168 if the group assigned thereto is predefined as relevant (or has an above threshold measure of relevancy) to the search query, but not if the group is predefined as irrelevant (or has a below threshold measure of relevancy).

Client computer 140 may display search results 168 of relevant entries on user interface 160, for example, as copies of or links to the original entries 172 (e.g., excerpts or urls of user comments or product review) or as processed data 170 derived from the entries. Search results 168 may be stored locally on client computer 140 or at a remote analysis engine 180.

Analysis engine 180 may search one or more information sources or databases, for example, using a. search application specific to each provider interface. In one embodiment, analysis engine 180 may use an API provided by the information source, or may use a. third-party search engine to search. In one embodiment, analysis engine 180 may search each information source remotely and may display the results of the search locally on client computer 140. In another embodiment, analysis engine 180 may search locally at the client side using processor 146 at client computer 140, for example, where analysis engine 180 is installed as a program and/or plug-in on client computer 140. Analysis engine 180 may have the capability to search and/or retrieve network 120 content, such as posts or entries from service providers. Analysis engine 180 may include hardware, for example, a sequence of logic units or software, for example, code or a software program including a sequence of instructions stored in memory unit 188, which when executed, search network 120 for content (e.g., posts relevant to a search query) using query expansion and disambiguation.

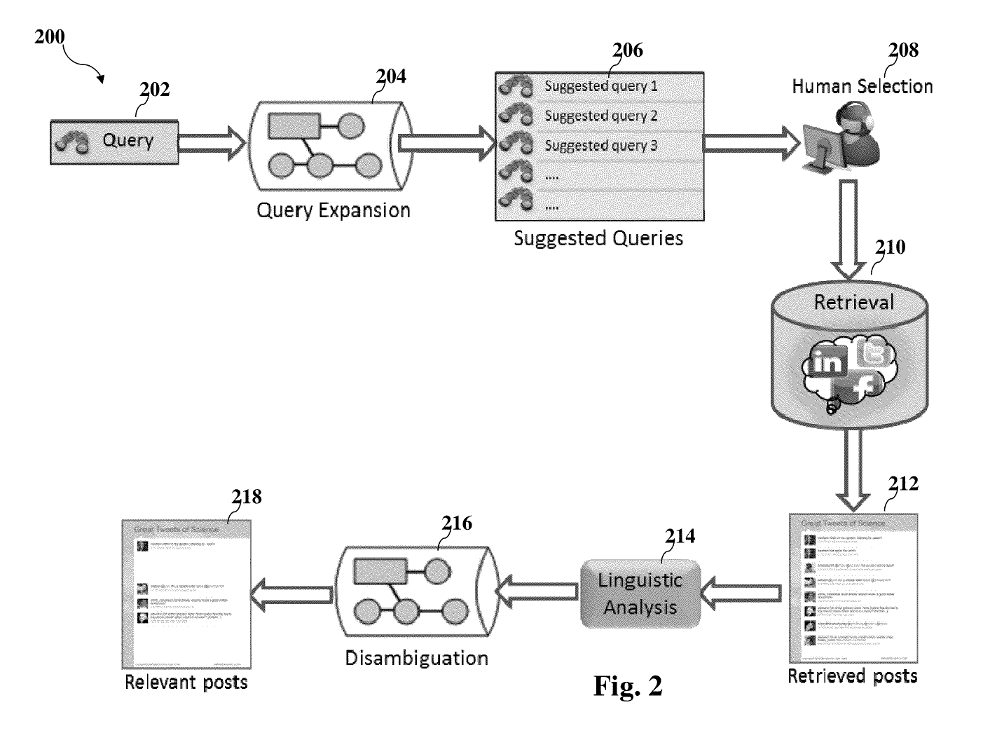

Reference is made to FIG. 2, which schematically illustrates a workflow 200 for searching for network data relevant to a search query using query expansion and disambiguation in accordance with embodiments of the invention. A system may include or use components of system 100 such as analysis engine 180 of FIG. 1 or a computing platform running at least one computer application to implement the workflow 200 of FIG. 2. However, other systems may be used.

in operation 202, a query may be received including one or more search terms (e.g., via query field 162 from client computer 140 of FIG. 1).

In operation 204, the query may he automatically expanded to generate a plurality of search terms in an extended set relevant to the initial search terms of the original (e.g., seed) query.

In operation 206, the extended set of a plurality of search terms in expanded search set field 164) may be displayed.

In operation 208, input may be received from a client computer (e.g., client computer 140 of FIG. 1) to edit the terms. The client may add (validate), delete (invalidate) or edit (rearrange letters in) terms in the extended query set.

In operation 210, information sources may be searched (e.g., via, network 120 of FIG. 1) for entries that (exactly or approximately) match the spelling of one or more of the terms in the edited extended query set, Matching entries 212 may be retrieved.

In operation 214, a linguistic analysis may be executed of the retrieved entries 212. Linguistic analysis of the retrieved entries may include part-of-speech (PUS) tagging, stemming, and/or extraction of syntactic phrases (e.g., noun phrases, verb phrases, etc.). PUS tagging may assign one or more PUS tags, such as noun, verb, preposition, etc., to one or more terms in the entries based on the definition and context of the terms. Word stemming may reduce inflection or may extract roots or base forms of terms in the entries, for example, a single form for nouns, a present tense for verbs, etc. The stemmed word may be a written form of the terms in the entries. In some embodiments, word stems may be analyzed, instead of the original terms that appear in the entries, to simplify disambiguation. PUS tagging and word stemming may be executed, for example, using the LinguistxPlatform tagging system manufactured by SAP AG of Waldorf, Germany, although other systems may be used.

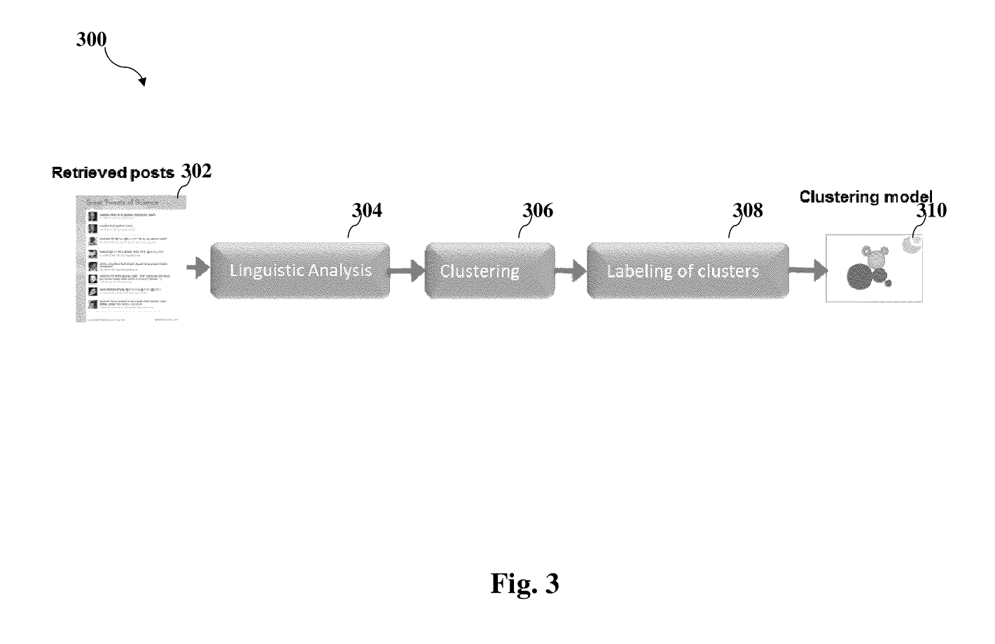

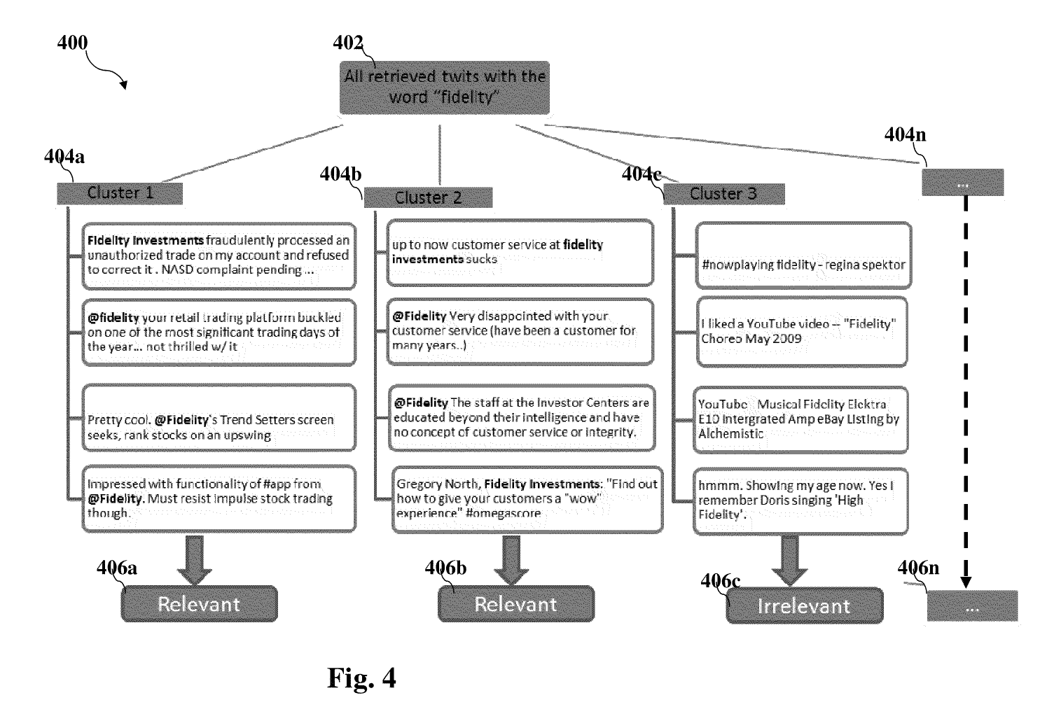

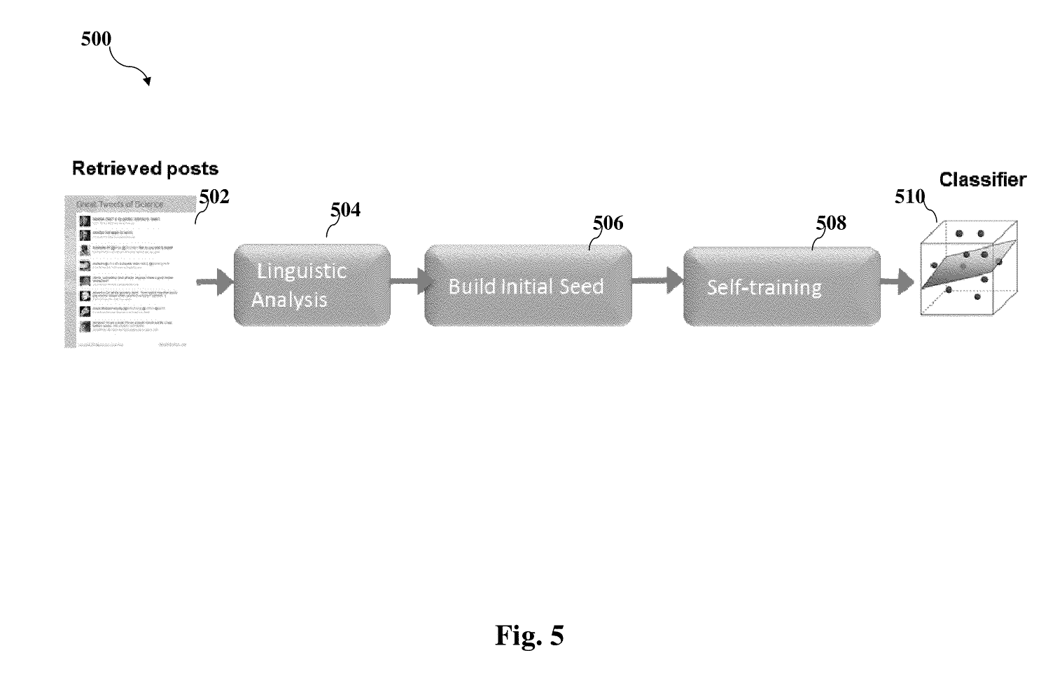

In operation 216, the relevancy of the retrieved entries may be determined to disambiguate the search. The relevancy of an entry to a query may be determined using machine learning techniques for training a model to disambiguate entries in a pre-search training stage. During the training stage, a model may be generated to recognize positive examples (e.g., relevant posts) and negative examples (e.g., irrelevant posts), for example, using either unsupervised or semi-supervised machine learning methods. Training may include a clustering process as described in reference to FIGS. 3 and 4 and/or a classification process as described in reference to FIG. 5, or other methods.

In the clustering process, each retrieved entry may be relevant if the group(s) to which the entry is assigned is predefined to be relevant to the query (or have a measure of relevancy above a predetermined threshold). In the classification process, classifiers may define each retrieved entry as relevant or irrelevant. Relevant search results 218 may be provided.

Other operations or orders of operations may be used.

Reference is made to FIG. 3, which schematically illustrates a workflow 300 for a clustering process in accordance with embodiments of the invention. A system may include or use components of system 100 such as analysis engine 180 of FIG. 1 to implement the workflow 300 of FIG. 3.

in operation 302, entries may be retrieved from information sources that match a query.

In operation 304, a linguistic analysis of the retrieved entries may be executed. Linguistic analysis of the retrieved entries may include POS tagging, stemming, and/or extraction of syntactic phrases (e.g., noun phrases, verb phrases, etc.).

In operation 306, retrieved entries may be clustered or gathered into groups based on the features extracted from their content. The features may include, for example, phrases extracted from the entries and the measure of semantic similarity between entries may be, for example, the Cosine similarity. The clusters may be grouped to reflect the semantic relationships, subject matter or themes in the entries. For example, entries with the word “fidelity” may be subdivided into groups which correspond to music, film, marriage, banking, or any other theme. The clustering process may include for example a partitioning process (e.g., a K-means process), a divisive top-down process (e.g., a bisecting K-means process), an agglomerative bottom-up process (e.g., an information bottleneck process), a process using topic models (e.g., Latent Dirichlet Allocation (IDA) models), or a combination of these or other processes, for example, each of which may be adapted according to embodiments of the invention. Other or different clustering processes or models may be used.

The computation of semantic similarity between posts may be enhanced by using knowledge sources, such as, WordNet or Wikipedia. In some embodiments, the number of similar words or terms in posts may increase the level of similarity between the posts. In one example, the following posts may be received:
i. “I swear Fidelity Investments automated system is the absolute worst!”
ii. “@Fidelity you did a horrible job today—your electronic trading platform failed at a critical time for many traders/investors—very bad!”
   In such an example, the following pairs of terms in the posts are determined to be similar:
1. “automated system” and “electronic platform.”
2. “Investments” and “investors.”
   Thus, the semantic similarity between the posts is increased,

In operation 308, a label or description may be assigned to each group or cluster as for example relevant or irrelevant (or may define a measure of relevancy for the group) to the search query. Labels other than relevant or irrelevant may be used. Group relevancy may be determined automatically by the analysis engine, by a user or client based on client-specified input, or by a combination of semi-automatic and semi-client specified operations. Automatic labeling may use strong positive (non-ambiguous) examples, for example, such as:
Posts sent to/from an account recognized by or associated with a query entity or organization.
Posts including an occurrence of a full non-ambiguous name, or high-confidential version of the name of the query entity.
Information extraction component that extracts related or alternative names of the query entity.

A group may be automatically labeled to be relevant (or with a degree of relevancy) to the query if an above threshold number or proportion of entries in a group are identified as relevant. Otherwise, group may be labeled as irrelevant. In other embodiments, input may be received from a user or client computer (e.g., client computer 140 of FIG. 1) to fully or partially define the labels for the groups. Partial client input may supplement semi-automatic labeling in which a plurality of proposed labeling schemes may be generated (e.g., each with different confidence levels) from which a client may select, validate, refine or modify the proposed schemes to label the groups.

A cluster model 310 may be provided including the plurality of groups or clusters generated in operation 306 each labeled as relevant and/or irrelevant (or having measures of relevancy or multiple labels) in operation 308. For each new search entry, the entry may be associated with one or more of the cluster groups. A search result may include entries that are associated with groups labeled as relevant or having an above threshold measure of relevancy,

Other operations or orders of operations may be used.

Reference is made to FIG. 4, which schematically illustrates an example of a cluster model 400 in accordance with embodiments of the invention.

Cluster model 400 may be trained or created to determine the relevancy of entries to a search query. A search query may include one or more search term, such as. “fidelity,” which may be input into an analysis engine (e.g., analysis engine 180 of FIG. 1) to search for posts, web pages, or other documents related to, for example, “Fidelity Investments,” but not for posts related to music, film or other usages of the search term, such as, “loyalty.” The search query may be expanded to include the original search term and alternate synonyms or related search terms, such as, “Fidelity Investments” and “@Fidelity” (the Twitter account name for Fidelity Investments). A client may add, validate or refine the search terms in the expanded query set.

Entries 402 may be retrieved from information sources (e.g., websites, databases, blogs, microblogs, tweets, e-mails, etc) that match or include one or more terms in the expanded query set. The analysis engine may search network data to identify entries 402 with (e.g., pre-indexed) content matching the query terms. Retrieved entries 402 may be provided to a client, for example, as a link (e.g., using a uniform resource locator (0), text excerpts of the related terms or phrases (e,g., ordered from highest to lowest relevancy), and/or associated statistical data (e.g., a number of matching entries 402, associated relevancy score(s) for each match, frequency of each query term, etc.).

Entries 402 may be divided into a plurality of groups or clusters 404a-404n in cluster model 400. Each group 404a-404n may be assigned a label 406a-406n, respectively, as relevant and/or irrelevant to the expanded query set (or having a measure of relevancy or multiple labels for different criteria).

In the example shown in FIG. 4, group 404a, including posts or entries 402 mostly related to stock trading, includes an above threshold number (e.g., majority) of entries 402 having terms that match positive examples (e.g., non-ambiguous organization names, such as, “Fidelity investments” and “@Fidelity”) relevant to terms in the expanded query set. Therefore, group 404a may be labeled as relevant. Group 404b, including entries 402 related to customer service, also includes an above threshold number of non-ambiguous names of Fidelity Investments, and therefore may also be labeled as relevant. However, group 404c, including entries 402 related to music or video, does not include positive examples of non-ambiguous names of Fidelity investments, and may therefore be labeled as irrelevant. The remaining groups 406d-406n may be labeled accordingly. Categorizations other than relevant and irrelevant may be used, and the specific terms relevant and irrelevant need not be used.

Reference is made to FIG. 5, which schematically illustrates a workflow 500 for a process of training a classifier in accordance with embodiments of the invention. A system may include or use components of system 100 such as analysis engine 180 of FIG. 1 to implement the workflow 500 of FIG. 5.

In operation 502, entries may be retrieved from information sources that match a query, for example, using pre-indexed network data.

In operation 504, a linguistic analysis of the retrieved entries may be executed. Linguistic analysis of the retrieved entries may include POS tagging, stemming, and/or extraction of syntactic phrases (e,g., noun phrases, verb phrases, etc.).

In operation 506, an initial seed may be used of positive (e.g., relevant) examples and negative irrelevant) examples to generate a classifier model to determine relevancy of new entries to the query. The initial seed of positive and negative examples may be generated using for example:
Posts sent to/from an account recognized by or associated with a query entity or organization.
Posts including an occurrence of a full non-ambiguous name, proper name, or high-confidential version of the name of the query entity.
Information extraction component that extracts related or alternative names of the query entity,
Posts generated by a clustering process, for example, as described in reference to FIGS. 3 and 4.
Posts generated or selected by a client.
   Other information may be used.

In operation 508, the positive and negative examples may be used in an iterative self-training process to train a classifier to define the new entries to be relevant or irrelevant to the query. The iterative self-training process may include, for example, bootstrapping or a label propagation process.

In a bootstrapping, the initial seed of positive and negative examples may be refined automatically in an iterative manner. Seed examples may be input as an initial set of labeled data and a classifier may be generated in accordance with the positive/negative examples of the initial set. The classifier may then be applied to a new set of unlabeled data. Examples that are classified with high confidence be added to a set of labeled data. The classifier may then be retrained or updated to classify the updated set of labeled data in accordance with the updated labeling. The process may proceed iteratively for each new set of unlabeled data, for example, until the accuracy or confidence of the classification converges to below a predetermined error threshold,

in a label propagation process, labeled and unlabeled examples may be represented as vertices in a connected graph. Label information may be iteratively propagated from any vertex to neighboring vertices through weighted edges. The labels of unlabeled examples may be inferred after the propagation process converges.

In some embodiments, semantic features of examples used for classification or labeling may be enhanced using secondary knowledge sources having predefined semantic features, such as, online dictionaries, encyclopedias, thesauruses or other linguistic references.

A classification model 510 may be provided including classifiers defined as relevant, irrelevant and/or having varying measures of relevancy to the query. Classification model 510 may be used to classify each new entry with classifiers and, according to the relevancy of the associated classifiers, may determine the relevancy of the entry. Relevant entries may be provided in a search result.

Other operations or orders of operations may be used.

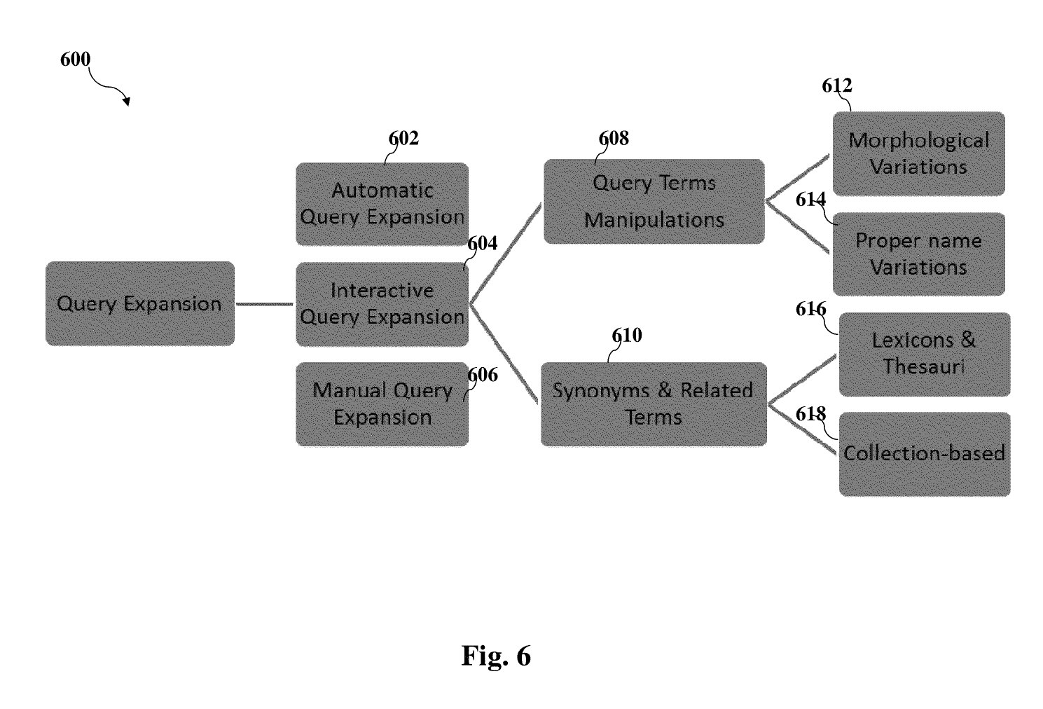

Once a disambiguation model (e.g., cluster model 310 of FIG. 3 or classifier model 510 of FIG. 5) is trained to determine the relevancy of example entries or previous entries to a query, the model may be used to determine the relevancy of new entries to the query. To search, the analysis engine may receive a query, perform a query expansion process (e.g., as described in reference to FIG. 6), refine the set of terms in the query expansion, retrieve new entries from information sources according to the expanded query set, analyze the linguistic features of the retrieved entries, determine the relevancy of the retrieved entries using the disambiguation model and/or determine an associated confidence score for the relevancy determination, and provide a search result of retrieved entries determined to be relevant and/or the associated confidence score for the relevancy determination.

If the output of the training stage is a clustering model, to search for an entry, the analysis engine may select one or more clusters that are most closely related to the entry, for example, using a similarity metric used by a discriminative clustering process and/or using inference computations for topic models. If the associated cluster is labeled as relevant then the entry may be determined to be relevant, otherwise, if this cluster is labeled as irrelevant then the entry may also be determined to be irrelevant. In one example discussed in reference to FIG. 4, an entry related to “Fidelity Investments” may read: “Fidelity didn't allow me to make trades today.” The entry may be associated with a cluster or group 404a related to stock trading. Since group 404a is labeled relevant, associated entry may be automatically determined to be relevant. However, an entry “@UserX@UserY TJ has she ever heard Fidelity? How do you hate that song?!?” is irrelevant since the entry may be associated with group 404c, which is labeled as irrelevant.

If the output of the training stage is a classifier model, an entry may be classified with a classifier,

Reference is made to FIG. 6, which schematically illustrates a query expansion model 600 in accordance with embodiments of the invention. A system may include components of system 100 such as analysis engine 180 of FIG. 1 to use and store the query expansion model 600 of FIG. 6.

Query expansion model 600 may be used to expand a query from one or more initial search terms to an expanded set of search terms. Query expansion model 600 may include an automatic query expansion 602, an interactive query expansion 604 and/or a manual query expansion 606. Automatic (e.g., performed by a computing system) query expansion 602 may include one or more terms automatically generated or retrieved from a database. Interactive query expansion 604 may use a semi-automatic expansion process in which one or more potential search terms may be retrieved from the database that may be verified by a user or client (e.g., via client computer 140 of FIG. 1) in an interactive feedback process. Manual query expansion 604 uses an expanded set of search terms received exclusively from the client.

Query expansion 602-606 may include query term manipulations 608, which may include morphological variations 612 and proper name variations 614. Morphological variations 612 may include terms generated by stemming the original query terms. Proper name variations 614 may include acronym variations of the query, key terms within the query to be used as standalone queries, and reformatted names.

Query expansion 602-606 may include synonymous or related terms 610, for example, determined to be synonymous, related or having a same or similar usage to the initial search terms of the original query. Synonymous or related terms 610 may be generated using lexicons and thesauri 616 provided by secondary knowledge databases (possibly on-line, e.g., accessed via the Internet), such as, thesauri, dictionaries and/or texicological databases indicating synonyms or words having similar roots or usages. The lexicons and thesauri 616 may include general or domain/field-specific terms. Synonymous or related terms 610 may be generated using a collection-based source 618 thesaurus, for example, automatically generated by tracking co-occurrence statistics over a collection of documents in a domain.

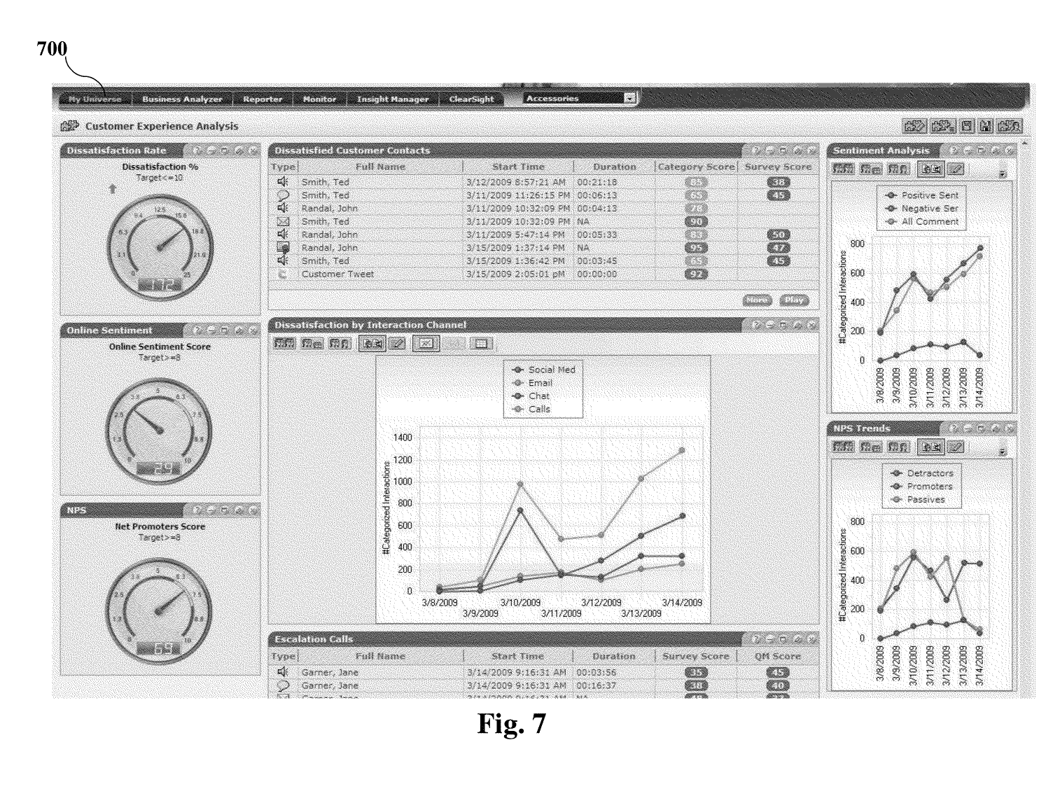

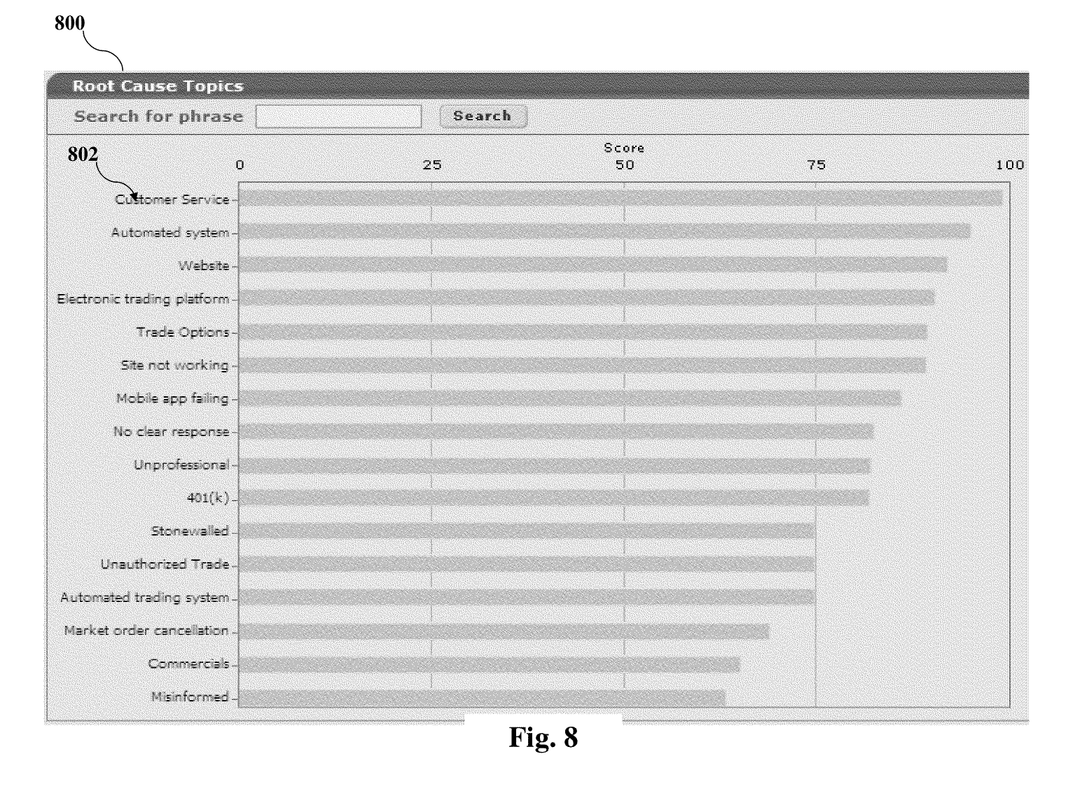

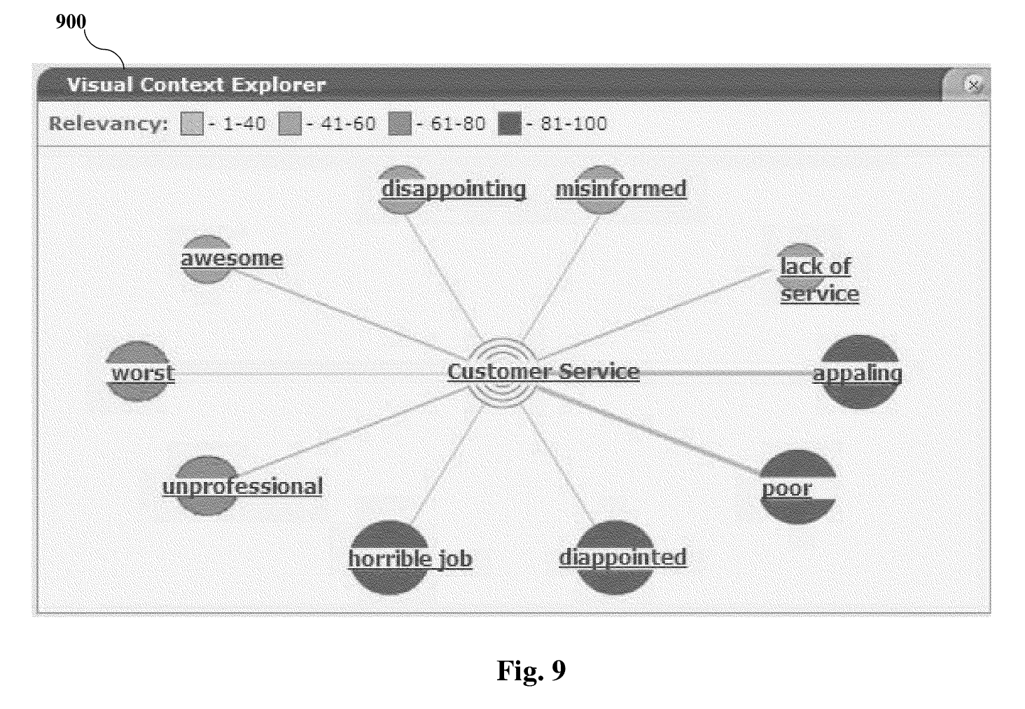

Reference is made to FIGS. 7-9, which are schematic illustrations of graphical user interfaces (GUIs) 700-900 for visualizing cross-channel content analysis accordance with embodiments of the invention. GUIs 700-900 may be displayed on a client computer (e.g., user interface 160 on client computer 140 of FIG. 1).

GUI 700 displays cross-channel content analysis, for example, of content provided via different types of communication channels, such as, call centers, e-mail servers, Internet chat-rooms and social media networks.

GUI 800 displays a root cause analysis, for example, of customer satisfaction for a company (e.g., Fidelity Investments); however an analysis of any other type may be used to define common topics. GUI 800 lists a plurality of topics 802.

GUI 900 displays a link analysis, for example, of one of the topics related to customer satisfaction. Although the link analysis shown in GUI 900 relates to customer satisfaction, link analyses may be related to any other topic.

Other or different visualizations may be used

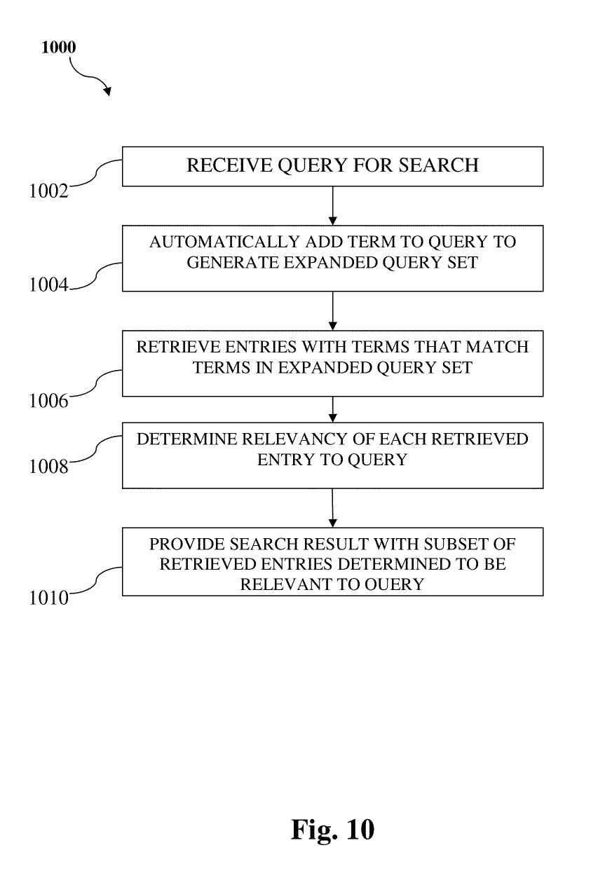

Reference is made to FIG. 10, which is a schematic illustration of a workflow 1000 for executing a query search in accordance with embodiments of the invention. A system may include or use components of system 100 such as analysis engine 180 of FIG. 1 or a computing platform running at least one computer application to implement the workflow 1000 of FIG. 10.

In operation 1002, a query comprising one or more search terms (e.g., “Fidelity customer service”) may be received from a user or client.

In operation 1004, at least one term may be automatically added to the query to generate an expanded query set. The additional terms may include alternate terms for expressing a similar expression to the query. For example, the search set may be expanded for the above example query “Fidelity Investments customer service” to include “Fidelity customer service,” “Fidelity representatives,” etc. More than one term may be added. The added term(s) are typically added at the end, e.g., after, or with lower priority to, the original query' terms.

In operation 1006, entries may be retrieved from one or more information sources that include terms that match terms in the expanded query set. In some embodiments the retrieval is over a network (e.g., via network 120 of FIG. 1) but in other embodiments other methods of data access may be used—e.g., a database internal to an organization or local on a computer may be used. The information sources may include, for example, e-mail servers, call centers, websites, databases, blogs, microblogs, social media networks, etc,

in operation 1008, a model may be used, executed or applied to determine the relevancy of each retrieved entry to the query. The model may be a clustering or classifier model, for example, as described in reference to FIGS. 3-5. Other models may be used.

In operation 1010, search results may be provided or displayed (e.g., on user interface 160 on client computer 140 of FIG. 1) including a subset of the retrieved entries (or links thereto) that are determined to be relevant to the query.

Other operations of orders of operations may be used.

Embodiments of the invention may include an article such as a computer or processor readable non-transitory storage medium, such as for example a memory, a disk drive, or a USB flash memory encoding, including or storing instructions, e.g., computer-executable instructions, which when executed by a processor or controller, cause the processor or controller (for example, analysis engine 180 and/or processor(s) 116, 136, 146, 156, of FIG. 1), to carry out methods disclosed herein.

Although the particular embodiments shown and described above will prove to be useful for the many distribution systems to which the present invention pertains, further modifications of the present invention will occur to persons skilled, in the art. All such modifications are deemed to be within the scope and spirit of the present invention as defined by the appended claims.

1. A method for searching text data comprising, using a processing component:
receiving a query comprising one or more terms;
automatically adding at least one term to the query to generate an expanded query set;
performing a search in one or more information sources using the expanded query set;
retrieving entries from the one or more information sources to serve as the results of said search, wherein the retrieved entries include terms that match terms in the expanded query set;
automatically determining the relevancy of each retrieved entry to the query; and
providing a search result comprising a subset of the retrieved entries that are determined to have sufficient relevancy to the query.

2. The method of claim 1 comprising using a model to determine the relevancy of each retrieved entry to the query.

3. The method of claim 2, wherein the model is generated by a clustering process.

4. The method of claim 3, wherein the model comprises a plurality of groups of entries, each group pre-defined as relevant, irrelevant or by a measure of relevancy to the query.

5. The method of claim 4 comprising, for each of one or more of the retrieved entries, selecting one of the plurality of groups in the model having entries most similar to the retrieved entry and providing the retrieved entry in the search result if the selected group is pre-defined to be relevant to the query or has a measure of relevancy to the query above a predetermined threshold.

6. The method of claim 5 comprising automatically defining a group to be relevant,
irrelevant or to have a measure of relevancy to the query depending on the number or proportion of entries in the group determined to be relevant.

7. The method of claim 2, wherein the model is generated by training a classifier.

8. The method of claim 7 comprising classifying each retrieved entry with the classifier.

9. The method of claim 1, wherein the added term of the expanded query set comprises one or more alternate terms for expressing a similar expression as the one or more original terms of the query.

10. The method of claim 1 comprising generating the additional term automatically added to the expanded query set by using a process selected from the group consisting of:
automatic query expansion, interactive query expansion, manual query expansion, query terms manipulation, morphological varying, proper name varying, synonyms and related term searching, lexicon and thesaurus searching, and collection-based thesaurus searching.

11. A system for searching text data comprising:
a memory to store a query comprising one or more terms; and
a processing component to receive the query, to automatically add at least one term to the query to generate an expanded query set, to perform a search in one or more information sources using the expanded query set, to retrieve entries from the one or more information sources to serve as the results of said search, wherein the retrieved entries include terms that match terms in the expanded query set, to automatically determine the relevancy of each retrieved entry to the query, to generate a search result comprising a subset of the retrieved entries that are determined to have sufficient relevancy to the query, and to provide a client computer with the search result.

12. The system of claim 11 comprising a remote server external to the client computer, wherein the remote server comprises the processing component.

13. The system of claim 11, wherein the processing component is to use a model to determine the relevancy of each retrieved entry to the query.

14. The system of claim 13, wherein the processing component is to generate the model using a clustering process.

15. The system of claim 13, wherein the processing component is to generate the model using a training process for building a classifier.

16. The method of claim 1, wherein:
determining the relevancy of each retrieved entry to the query is performed using positive examples of entries predefined to be relevant to the search query and negative examples predefined to be irrelevant to the search query;

17. The method of claim 16, wherein the positive and negative examples are defined by a model.

18. The method of claim 17, wherein the model is a cluster model.

19. The method of claim 17, wherein the model is a classifier model.

20. The method of claim 16 comprising expanding an initial search term to generate a plurality of search terms included in the search query,
